(19) United States
(12) Patent Application Publication
(10) Pub. No.: US 2026/0230116 A1
(43) Pub. Date: Aug. 6, 2026

(54) Wireless Communication System

(71) Applicant: SIEMENS AKTIENGESELLSCHAFT, München (DE)

(72) Inventors: Janos GILA, Mödling (AT); Andreas HOFMANN, Wien (AT); Lukas Walter MAYER, Wien (AT); Martin SCHIEFER, Pölten (AT)

(21) Appl. No.: 19/147,177

(22) PCT Filed: Dec. 22, 2023
(86) PCT No.: PCT/EP2023/087687

§ 371 Date: Jul. 10, 2025

(30) Foreign Application Priority Data
Jan. 12, 2023 (EP) 23151414

(51) Int. Cl. H04B 7/04; H04B 7/06

(52) U.S. Cl. CPC H04B 7/04013; H04B 7/0617

(57) ABSTRACT

A wireless communication system in which a transmitter transmits a signal toward first and at least one second reflectors that receive and reflect the signal toward a receiver, where the first and second reflectors each additionally reflect the signal within an angular range from/to respective first and second limits with angle-dependent reflection factors, the signal path of the respectively signal has respective first and second lengths at the respective first and second limits, and the signal path of the reflected signal has a middle length in the center between the respective first and second limits, a relative difference in length (DL) between the respective first and second lengths is at least 20%, and the first and second reflectors increase respective angle-dependent reflection factors at the respective first limit in relation to the respective middle length and reduce the respective angle-dependent reflection factor at the respective second limit.

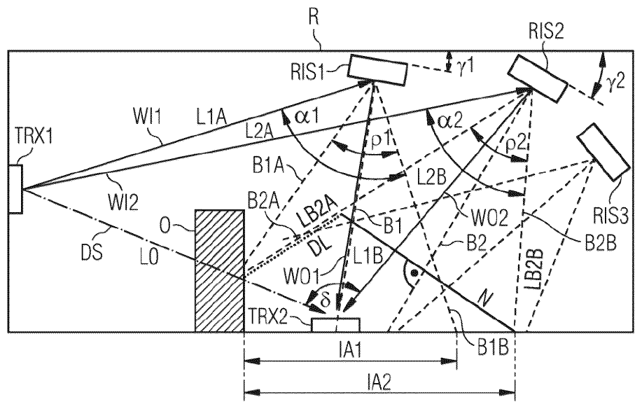

### CROSS-REFERENCE TO RELATED APPLICATIONS

This is a U.S. national stage of application No. PCT/EP 2023/087687 filed 22 Dec. 2023. Priority is claimed on European Application No. 23151414.2 filed 12 Jan. 2023, the content of which is incorporated herein by reference in its entirety.

### 1. FIELD OF THE INVENTION

The invention relates to a wireless communication system.

### 2. DESCRIPTION OF THE RELATED ART

Electronically controllable reflectors can be widely used, for example, to improve a signal illumination from a transmitter to locations shaded by obstacles or objects.

This can occur, for example, in a factory building to improve the reception properties of individual work areas with radio systems used there, such as according to the 5G standard, with the aid of a respective electronically controllable reflector, and to create a radio link which does not have direct communication between transmitter and receiver, i.e., a covered link (non-line of sight).

An electronically intelligently controllable reflector can be individually separated spatially into a reflection angle, i.e., into a horizontal angle Phi as well as into a vertical angle Theta, and can be adaptively changed.

The reflection properties of the reflector can thereby be set over the entire work area.

However, the possible angle settings for the angles Phi and Theta tend to be tightly restricted, and this limits application of an intelligently and electronically controllable reflector.

Furthermore, it is possible that the available field strength of the received signal is not sufficient to ensure good reception and implement reliable decoding.

### SUMMARY OF THE INVENTION

It is an object of the invention to provide an arrangement of a wireless communication system that permits an improved field of application and also provides greater system availability.

This and other objects and advantages are achieved in accordance with the invention by a wireless communication system, comprising a transmitter, a receiver and a first electronically controllable reflector at a first location and at least one second electronically controllable reflector at at least one second location, where the transmitter is configured to transmit a respective signal in the direction of the first reflector and the at least one second reflector, and the first and the at least one second reflector are configured to receive the respective signal and to reflect it toward the receiver, where the first reflector and the at least one second reflector are furthermore each configured to reflect the respective signal within an angular range from a respective first limit to a respective second limit with angle-dependent reflection factors, where the respective signal path of the respectively reflected signal has a respective first length at the respective first limit between the reflector and an arrival location of the reflected signal, the respective signal path of the respectively reflected signal has a respective second length at the respective second limit, and the respective signal path of the respectively reflected signal has a respective middle length in the respective center between the respective first and the respective second limit, a respective relative difference in length between the respective first length and the respective second length is at least 20%, and where the first and the at least one second reflector are jointly configured to increase the respective angle-dependent reflection factor at the respective first limit in relation to the respective middle length and to reduce the respective angle-dependent reflection factor at the respective second limit.

In the present context, “respective” lengths, respective signal paths, respective reflected signals, respective limits, respective angular ranges should be taken to mean that for each controllable reflector, there exists a separate signal path with the described physical, electrical and geometric properties that are defined analogously to one other for each reflector in the system.

If a plurality of controllable reflectors are mounted at a plurality of locations and are operated accordingly, which reflectors are configured to illuminate the same surface at which the receiver is arranged, then an increased field strength can thus be provided for the receiver and the system availability improved as a result.

The arrangement is not a mere sequence of a plurality of reflectors as said configuration of the reflectors permits an appropriately combined, joint configuration, moreover.

A joint configuration of this kind can occur in a configuration apparatus that is also encompassed by the communication system and is configured to actuate the first and the at least one second reflector accordingly.

The reflected signal thus illuminates an arrival location that can be formed by a surface, such as the floor, upon which the receiver is arranged.

The arrival location of the reflected receiver can also be formed by other objects, such as a wall or other obstacles.

For this, the geometry of the arrangement, such as in a space, is captured and converted into a corresponding distribution of the reflection properties of the controllable reflector elements of the reflectors with the aid of geometric operations.

The first and the at least one second reflector each have controllable reflector elements with respectively adjustable reflection factors. Appropriate actuation of the arranged reflector elements makes it possible for the reflection properties of the reflector to be set, for example, in an angle-dependent manner, and this can be represented with the aid of an antenna/reflector aperture.

The relative length difference can be based, for example, on the first or second length, or optionally also on the length of the shortest, direct transmission path from reflector to receiver.

In one embodiment of the invention, the respective relative length difference is at least 30% and preferably at least 50%.

In another embodiment of the invention, the system is arranged in a space.

In a further embodiment of the invention, a respectively imaginary sight line with a respective sight line length is formed between the transmitter and the receiver, and a transmission route is formed between the transmitter, the controllable reflector and the receiver, and a respectively imaginary triangle made of a respective first part length of the transmission route, which is located between the transmitter and the reflector, a respective second part length of the transmission route, which is located between the reflector and the receiver, and the respective sight line length has a respective obtuse angle at the receiver.

The objects and advantages are also achieved in accordance with the invention by a system in which the first and the at least one second reflector are also configured to reflect the respective signal within an angular range from a respective first limit to a respective second limit with angle-dependent reflection factors in each case, where the respective signal path of the respectively reflected signal has a respective first length at the respective first limit, the respective signal path of the respectively reflected signal has a respective second length at the respective second limit, the respective signal path of the respectively reflected signal has a respective middle length in the respective center between the respective first and the respective second limit, a respective imaginary sight line with a respective sight line length is formed between the transmitter and the receiver, and a respectively imaginary triangle made of the respective first length, the respective second length and the respective sight line length has a respective obtuse angle at the receiver, and the first and the at least one second reflector is configured to increase the respective angle-dependent reflection factor at the respective first limit in relation to the respective middle length and to reduce the respective angle-dependent reflection factor at the respective second limit.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained in more detail below on the basis of an exemplary embodiment represented in the accompanying drawings, in which:

The FIGURE shows a first exemplary embodiment of the invention.

### DETAILED DESCRIPTION OF THE EXEMPLARY EMBODIMENTS

With reference to the FIGURE, a wireless communication system is shown therein, which comprises a transmitter TRX1, a receiver TRX2 and an electronically controllable reflector RIS1.

A signal WI1 can be transmitted from the transmitter TRX1 to a reflector RIS1 and can be reflected onwards as a signal WO1 to a receiver TRX2, with the signal covering lengths LA and L1B.

The reflector has a controllable range ρ1.

The arrangement of transmitter TRX1, reflector RIS1 and receiver TRX2 together with a mounting angle γ1 of the reflector forms an effective angular range α1 for the reflector RIS1.

The receiver TRX2 can be arranged within an illuminated surface IA1 in which the signal transmitted by the transmitter TRX1 can be received with the aid of the reflector RIS1.

With further reference to FIGURE, the inventive wireless communication system illustrated therein comprises a transmitter TRX1, a receiver TRX2 and an electronically controllable reflector RIS2 and is arranged in a space R.

The transmitter TRX1 is configured to transmit a signal WI2 in the direction of the reflector RIS2.

The intelligent, electronically controllable reflector RIS2 is configured to receive the signal from the transmitter TRX1 and reflect it onwards as signal WO2 in the direction of the receiver TRX2.

The signal path B1 of the reflected signal in the center between the first and the second limit B1A, B1B of the first reflector RIS1 has a middle length.

The reflector RIS2 has a controllable range ρ2 that can correspond to the controllable range ρ1 of the reflector RIS1. The arrangement of transmitter TRX1, reflector RIS1 and receiver TRX2 together with a mounting angle γ2 of the reflector, measured in relation to the horizonal of the space R, forms an effective angular range α2 for the reflector RIS2.

As evident from the FIGURE, the effective angular range α2 for the reflector RIS2 is significantly more than the effective angular range α1 for the reflector RIS1.

The illuminated surface IA2 due to the reflector RIS2 is therefore greater than the illuminated surface IA1 due to the reflector RIS1.

It is clear that a transmission can also occur in the opposite direction if respective transceiver functions exist in the case of transmitter and receiver.

The reflector RIS2 is also configured to reflect the signal within an angular range from a first limit B2A to a second limit B2B with angle-dependent reflection factors.

The signal path of the reflected signal at the first limit B2A has a first length LB2A.

The signal path of the reflected signal at the second limit B2B has a second length LB2B.

The signal path of the respectively reflected signal is located between the reflector RIS2 and an arrival location of the reflected signal.

The signal path B2 of the reflected signal in the center between the first and the second limit B2A, B2B of the second reflector RIS2 has a middle length.

A relative difference in length DL between the first length LB2A and the second length LB2B is at least 20%, optionally at least 30% and preferably at least 50%.

The relative difference in length DL can be based, for example, on the first or second length LB2A, LB2B, or optionally also on the length L2B.

The relative difference in length DL can be formed, for example, because a normal N is located at the signal path B2 of the reflected signal in the center between the first and second limit B2A, B2B, with the normal N extending through the point of intersection of the second limit B2B and the plane that is formed by the receiver TRX2, such as the floor of the space R.

The portion on the limit B2A, which is defined between the point of intersection of the first limit B2A and the normal N, as well as the plane that is formed by the receiver TRX2, such as the floor of the space R, or also by a point of intersection with an obstacle-object O, can be defined as the relative difference in length DL.

The reflector RIS2 is also configured to increase the reflection factor in an angle-dependent manner at the first limit B2A in relation to the middle length LB2 and to reduce the reflection factor in an angle-dependent manner at the second limit B2A.

Alternatively or in addition, an imaginary sight line DS can be formed with a length of the sight lines L0 between the transmitter TRX1 and the receiver TRX2.

The signal path of the respectively reflected signal is formed between the reflector RIS2 and an arrival location of the reflected signal.

Furthermore, an imaginary triangle made of a first part length L2A, a second part length L2B and the sight line length LO can have an obtuse angle δ at the receiver TRX2.

The first part length L2A of the transmission route is located between the transmitter TRX1 and the reflector RIS2.

A second part length L2B of the transmission route is located between the reflector RIS2 and the receiver TRX2.

The receiver TRX2 can be arranged within an illuminated surface IA2 in which the signal transmitted by the transmitter TRX1 can be received with the aid of the reflector RIS2.

The same considerations apply to a further, second controllable reflector RIS3 that is mounted at a different location in the space R and is operated accordingly, and that is also configured to illuminate the same surface IA2 to provide an increased field strength for the receiver TRX2 and to improve the system availability as a result.

The reflectors RIS2, RIS3 are configured in a combined manner, i.e., jointly.

A joint configuration of this kind can occur in a configuration apparatus with a processor and a memory (not shown in the FIGURE), which actuates the first and the at least one second reflector accordingly.

For this, the geometry of the arrangement in the space R can be captured and be converted into a corresponding distribution of the reflection properties for the controllable reflector elements of the reflectors RIS2, RIS3 with the aid of mathematical, geometric operations.

If the positions of the transmitter TRX1, the reflectors RIS2, RIS3 and the receiver TRX2 (based on the wavelength of the communication frequency of the transmission system) are not adequately known, then the configuration of the reflectors RIS2, RIS3 can thus be supported, for example, by an optimization method that maximizes the reception power at the receiver TRX2.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements that perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-4. (canceled)

5. A wireless communication system, comprising:
a transmitter;
a receiver; and
a first electronically controllable reflector arranged at a first location and at least one second electronically controllable reflector arranged at at least one second location;
wherein the transmitter is configured to transmit a respective signal toward the first reflector and the at least one second reflector;
wherein and the first and the at least one second reflectors are configured to receive and reflect the respective signal toward the receiver;
wherein the first and the at least one second reflectors are each further configured to reflect the respective signal within an angular range from a respective first limit to a respective second limit with angle-dependent reflection factors;
wherein the respective signal path of the respectively reflected signal, between the reflector and an arrival location of the reflected signal, has a respective first length at the respective first limit;
wherein the respective signal path of the respectively reflected signal has a respective second length at the respective second limit and the respective signal path of the respectively reflected signal has a respective middle length in a respective center between the respective first and the respective second limit;
wherein a respective relative difference in length between the respective first length and the respective second length is at least 20%; and
wherein the first and the at least one second reflector are jointly configured to increase the respective angle-dependent reflection factor at the respective first limit in relation to the respective middle length and to reduce the respective angle-dependent reflection factor at the respective second limit.

6. The system as claimed in claim 5, wherein the respective relative length difference is at least 30%.

7. The system as claimed in claim 5, wherein the respective relative length difference is at least 50%.

8. The system as claimed in claim 5, wherein the system is arranged in a space.

9. The system as claimed in claim 5, wherein a respectively imaginary sight line with a respective sight line length is formed between the transmitter and the receiver;
wherein a transmission route is formed between the transmitter, the controllable reflector and the receiver, and a respectively imaginary triangle made of a respective first part length of the transmission route, which is located between the transmitter and the reflector;
wherein a respective second part length of the transmission route, which is located between the reflector and the receiver, and the respective sight line length has a respective obtuse angle at the receiver.
